(19) United States
(12) Patent Application Publication
(10) Pub. No.: US 2014/0211861 A1
(43) Pub. Date: Jul. 31, 2014

(54) METHOD AND SYSTEM FOR PROVIDING HIGH DEFINITION (HD) BROADCASTING SERVICE AND ULTRA HIGH DEFINITION (UHD) BROADCASTING SERVICE

(71) Applicant: Electronics and Telecommunications Research Institute, Daejeon (KR)

(72) Inventors: Gwang Soon LEE, Daejeon (KR); Sung Ik PARK, Daejeon (KR); Heung Mook KIM, Daejeon (KR); Nam Ho HUR, Daejeon (KR)

(73) Assignee: Electronics and Telecommunications Research Institute, Daejeon (KR)

(21) Appl. No.: 14/163,982

(22) Filed: Jan. 24, 2014

(30) Foreign Application Priority Data
Jan. 25, 2013 (KR) 10-2013-0008628
Aug. 28, 2013 (KR) 10-2013-0102430

(51) Int. Cl. H04N 19/40; H04N 19/89

(52) U.S. Cl. CPC H04N 19/00472; H04N 19/00939
USPC 375/240.27

(57) ABSTRACT

A method of transmitting a high definition (HD) image and an ultra high definition (UHD) image, the method including obtaining a first HD image by down-scaling an original UHD image, obtaining at least one of a second HD image and a half-resolution UHD image by down-scaling the original UHD image, encoding the first HD image, encoding at least one of the second HD image and the half-resolution UHD image, generating a first transmission stream by multiplexing and synchronizing the encoded first HD image, generating a second transmission stream by multiplexing and synchronizing at least one of the encoded second HD image and the encoded half-resolution UHD image, transmitting the first transmission stream via a first transmission channel, and transmitting the second transmission stream via a second transmission channel differing from the first transmission channel is provided.

### CROSS-REFERENCE TO RELATED APPLICATIONS

This application claims the priority benefit of Korean Patent Application No. 10-2013-0008628, filed on Jan. 25, 2013, and Korean Patent Application No. 10-2013-0102430, filed on Aug. 28, 2013, in the Korean Intellectual Property Office, the disclosures of which are incorporated herein by reference.

### BACKGROUND

1. Field of the Invention

The present invention relates to a system and method for providing a high definition broadcasting service and an ultra high definition (UHD) service, and more particularly, to technology for simultaneously providing an HD image and a UHD image by transmitting/receiving image information for a UHD broadcasting service via a channel differing from a channel via which image information for an HD broadcasting service is transmitted/received.

2. Description of the Related Art

A system for providing a broadcasting service based on an advanced television system committee (ATSC) digital television broadcasting transmission method may have a physical limit in transmitting an ultra high definition (UHD) image because a bandwidth of a transmission signal is 19 megabits per second (Mbps) in 6 megahertz (MHz). Also, additional transmission technology or codec technology may be required to simultaneously provide an HD image and a UHD image in an identical channel to guarantee reverse scalability compatibility.

### SUMMARY

According to an aspect of the present invention, there is provided a method of transmitting a high definition (HD) image and an ultra high definition (UHD) image, the method including obtaining a first HD image by down-scaling an original UHD image, obtaining at least one of a second HD image and a half-resolution UHD image by down-scaling the original UHD image, encoding the first HD image, encoding at least one of the second HD image and the half-resolution UHD image, generating a first transmission stream by multiplexing and synchronizing the encoded first HD image, generating a second transmission stream by multiplexing and synchronizing at least one of the encoded second HD image and the encoded half-resolution UHD image, transmitting the first transmission stream via a first transmission channel, and transmitting the second transmission stream via a second transmission channel differing from the first transmission channel.

The encoding of the at least one of the second HD image and the half-resolution UHD image may further include reference encoding the at least one of the second HD image and the half-resolution UHD image with respect to the first HD image, based on an inter-picture prediction method.

The transmitting of the first transmission stream via the first transmission channel may include performing error correction encoding processing on the first transmission stream, and the transmitting of the second transmission stream via the second transmission channel differing from the first transmission channel may include performing error correction encoding processing on the second transmission stream.

According to an aspect of the present invention, there is provided a method of transmitting an HD image and a UHD image, the method including obtaining a first HD image by down-scaling an original UHD image, obtaining an up-scaled image by up-scaling the first HD image, generating a difference image between the original UHD image and the up-scaled image, obtaining, from the difference image, at least one of the second HD image and the UHD image corresponding to the difference image, encoding the first HD image, encoding at least one of the second HD image and the UHD image, generating a first transmission stream by multiplexing and synchronizing the encoded first HD image, generating a second transmission stream by multiplexing and synchronizing at least one of the encoded second HD image and the encoded UHD image, transmitting the first transmission stream via a first transmission channel, and transmitting the second transmission stream via a second transmission channel distinguished from the first transmission channel.

The obtaining of the at least one of the second HD image and the UHD image from the difference image may include obtaining the second HD image by down-scaling the difference image.

The transmitting of the first transmission stream via the first transmission channel may include performing error correction encoding processing on the first transmission stream, and the transmitting of the second transmission stream via the second transmission channel distinguished from the first transmission channel may include performing error correction encoding processing on the second transmission stream.

According to an aspect of the present invention, there is provided a method of receiving an HD image and a UHD image, the method including receiving a first transmission stream via a first transmission channel, receiving a second transmission stream via a second transmission channel distinguished from the first transmission channel, demultiplexing and synchronizing the first transmission stream, demultiplexing and synchronizing the second transmission stream, generating a first HD image by decoding the demultiplexed and synchronized first transmission stream, generating the first UHD image by decoding the demultiplexed and synchronized second transmission stream, generating an up-scaled image by up-scaling the first HD image, generating a second UHD image by combining the up-scaled image and the first UHD image, and providing the first HD image and the second HD image.

The generating of the first UHD image by decoding the demultiplexed and synchronized second transmission stream may further include generating at least one of a second HD image and a half-resolution UHD image by decoding the demultiplexed and synchronized second transmission stream, and generating the first UHD image by up-scaling at least one of the second HD image and the half-resolution UHD image.

The generating of the first UHD image by up-scaling the at least one of the second HD image and the half-resolution UHD image may further include interpolating at least one of the second HD image and the half-resolution UHD image.

The generating of the second UHD image by combining the up-scaled image and the first UHD image may further include interpolating the image combined by the up-scaled image and the first UHD image.

The receiving of the first transmission stream via the first transmission channel may include generating the first transmission stream by channel decoding a signal received via the first transmission channel, and the receiving of the second transmission stream via the second transmission channel may include generating the second transmission stream by channel decoding a signal received via the second transmission channel.

According to an aspect of the present invention, there is provided a system for transmitting an HD image and a UHD image, the system including a first down-scaler to obtain a first HD image by down-scaling an original UHD image, a second down-scaler to obtain at least one of a second HD image and a half-resolution UHD image by down-scaling the original UHD image, a first image encoder to encode the first HD image, a second image encoder to encode at least one of the second HD image and the half-resolution UHD image, a multiplexer to generate a first transmission stream by multiplexing and synchronizing the encoded first HD image, and generate a second transmission stream by multiplexing and synchronizing at least one of the encoded second HD image and the encoded half-resolution UHD image, and a transmitter to transmit the first transmission stream via a first transmission channel, and transmit the second transmission stream via a second transmission channel distinguished from the first transmission channel.

According to an aspect of the present invention, there is provided a system for transmitting an HD image and a UHD image, the system including a first down-scaler to obtain a first HD image by down-scaling an original UHD image, an up-scaler to obtain an up-scaled image by up-scaling the first HD image, a difference image generator to generate a difference image between the original UHD image and the up-scaled image, an image generator to obtain at least one of a second HD image and a UHD image corresponding to the difference image from the difference image, a first image encoder to encode the first HD image, a second image encoder to encode at least one of the second HD image and the UHD image, a multiplexer to generate a first transmission stream by multiplexing and synchronizing the encoded first HD image, and generate a second transmission stream by multiplexing and synchronizing at least one of the encoded second HD image and the encoded UHD image, and a transmitter to transmit the first transmission stream via the first transmission channel, and transmit the second transmission stream via a second transmission channel differing from the first transmission channel.

The image generator may include a second down-scaler to obtain the second HD image by down-scaling the difference image.

According to an aspect of the present invention, there is provided a system for receiving an HD image and a UHD image, the system including a receiver to receive a first transmission stream via a first transmission channel, and receive a second transmission stream via a second transmission channel distinguished from the first transmission channel, a demultiplexer to demultiplex and synchronize the first transmission stream, and demultiplex and synchronize the second transmission stream, a first image decoder to generate a first HD image by decoding the demultiplexed and synchronized first transmission stream, a second image decoder to generate a first UHD image by decoding the demultiplexed and synchronized second transmission stream, a first up-scaler to obtain an up-scaled image by up-scaling the first HD image, a first image generator to generate a second UHD image by combining the up-scaled image and the first UHD image, and an image provider to provide the first HD image and the second UHD image.

The second image decoder may further include a second image generator to generate at least one of a second HD image and a half-resolution UHD image by decoding the demultiplexed and synchronized second transmission stream, and a second up-scaler to generate the first UHD image by up-scaling at least one of the second HD image and the half-resolution UHD image.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a system for providing a high definition (HD) image and an ultra high definition (UHD) image according to an embodiment of the present invention;

FIG. 2 is a diagram illustrating a first transmission system for transmitting an HD image and a UHD image according to an embodiment of the present invention;

FIG. 3 is a diagram illustrating a process of using a down-scaling method in a first transmission system according to an embodiment of the present invention;

FIG. 4 is a diagram illustrating a second transmission system for transmitting an HD image and a UHD image according to an embodiment of the present invention;

FIG. 5 is a diagram illustrating a process of using a down-scaling method and an up-scaling method in a second transmission system according to an embodiment of the present invention;

FIG. 6 is a diagram illustrating a reception system for receiving an HD image and a UHD image according to an embodiment of the present invention;

FIGS. 7A and 7B are diagrams illustrating a process of using a down-scaling method and an up-scaling method in a reception system corresponding to a first transmission system according to an embodiment of the present invention;

FIG. 8 is a diagram illustrating a process of using a down-scaling method and an up-scaling method in a reception system corresponding to a second transmission system according to an embodiment of the present invention;

FIG. 9 is a flowchart illustrating a method of transmitting an HD image and a UHD image by a first transmission system according to an embodiment of the present invention;

FIG. 10 is a flowchart illustrating a method of transmitting an HD image and a UHD image by a second transmission system according to an embodiment of the present invention;

FIG. 11 is a flowchart illustrating a method of receiving an HD image and a UHD image by a reception system according to an embodiment of the present invention;

FIG. 12 is a block diagram illustrating a first transmission system according to an embodiment of the present invention;

FIG. 13 is a block diagram illustrating a second transmission system according to an embodiment of the present invention; and

FIG. 14 is a block diagram illustrating a reception system according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

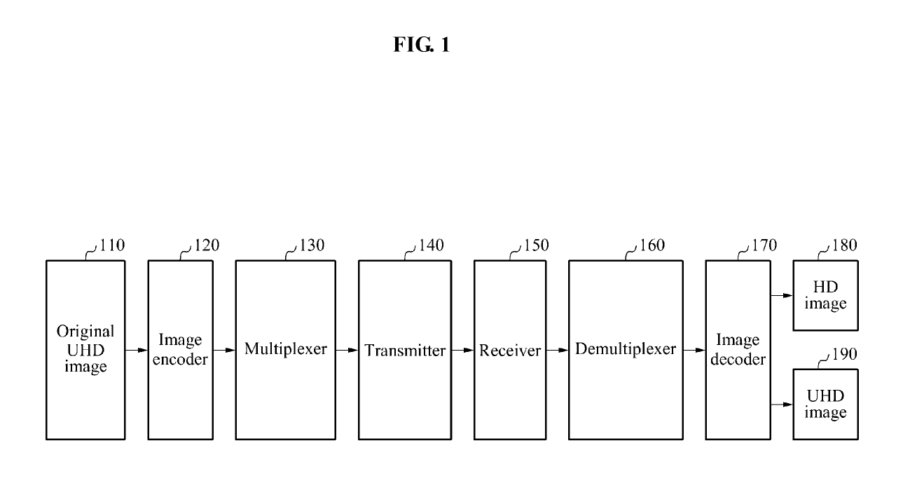

FIG. 1 is a diagram illustrating a system for providing a high definition (HD) image and an ultra high definition (UHD) image according to an embodiment of the present invention.

Referring to FIG. 1, the system for providing the HD image and the UHD image includes a transmission system and a reception system.

For example, the transmission system includes an image encoder 120 for encoding images obtained from an original UHD image 110, a multiplexer 130 for generating a plurality of transmission streams by multiplexing and synchronizing the each of the encoded images, and a transmitter 140 for appropriately distributing and transmitting the plurality of transmission streams via a plurality of differing channels. The image encoder 120 obtains an HD image or a half-resolution UHD image from the original UHD image 110 and encodes the HD image or the half-resolution UHD image by including a down-scaler that down-scales, for example, decreases, a resolution of the original UHD image 110, and generates a difference image between the original UHD image 110 and an up-scaled image and encodes the difference image by including an up-scaler that up-scales, for example, increases, a resolution of a down-scaled image. Also, the image encoder 120 selectively reference encodes the down-scaled image, based on an inter-picture prediction method.

Also, the transmitter 140 includes an error correction encoder for performing error correction encoding processing on the plurality of transmission streams, and a modulator.

The reception system includes a receiver 150 for receiving a plurality of streams via respective differing channels, a demultiplexer 160 for demultiplexing and synchronizing the plurality of transmission streams, and an image decoder 170 for generating a restored HD image 180 and a restored UHD image 190 by decoding the plurality of demultiplexed and synchronized transmission streams. Also, the reception system further includes an image provider for providing the restored HD image 180 and the restored UHD image 190.

For example, the image decoder 170 combines an up-scaled image and a UHD image obtained from a plurality of transmission streams, and generates the restored UHD image 190 by including an up-scaler that up-scales, for example, increases a resolution of an image obtained from the plurality of transmission streams. In this example, an interpolating process may be included in the generating of the restored UHD image 190 or the obtaining of the UHD image from the plurality of transmission streams.

Further, the receiver 150 includes a demodulator for demodulating and channel decoding a signal received via a plurality of differing channels, and generating a plurality of transmission streams, and an error correction decoder.

The system for providing the HD image and the UHD image guarantees reverse scalability compatibility by including an encoder for encoding an HD image in a transmission system and a decoder for outputting an HD image in a reception system.

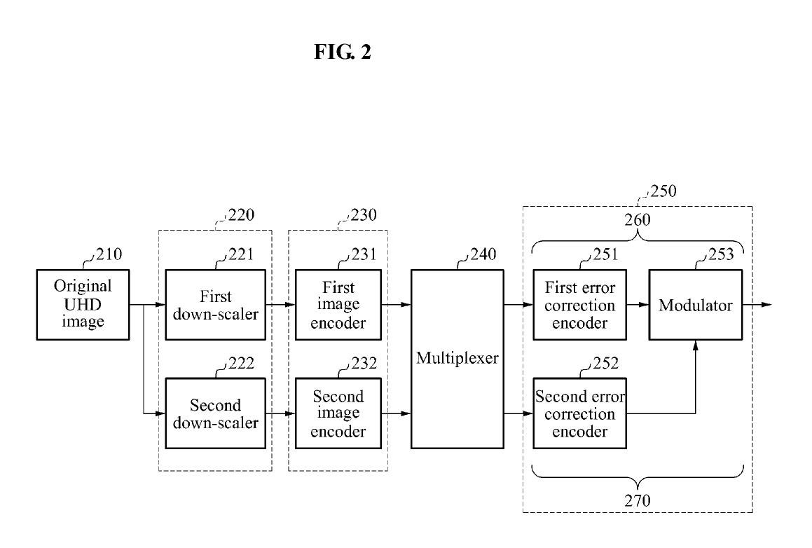

FIG. 2 is a diagram illustrating a first transmission system for transmitting an HD image and a UHD image according to an embodiment of the present invention.

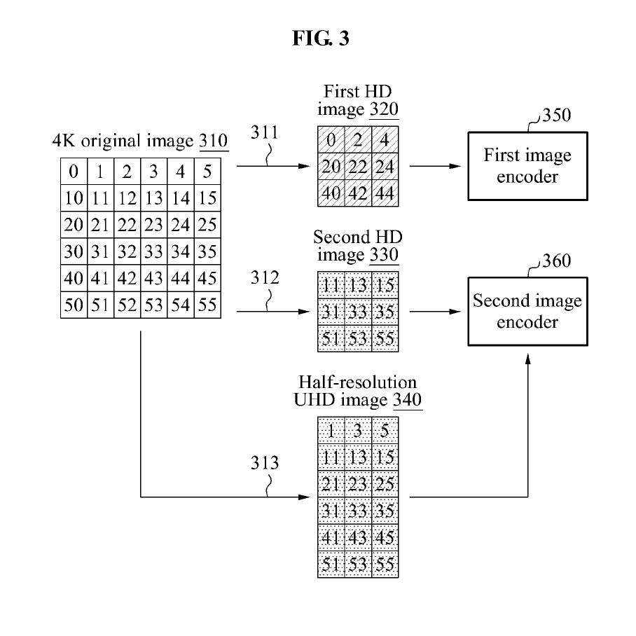

Referring to FIG. 2, the first transmission system includes a down-scaler 220, an image encoder 230, a multiplexer 240, and a transmitter 250. For example, the down-scaler 220 includes a first down-scaler 221 for obtaining a first HD image by down-scaling an original UHD image 210, and a second down-scaler 222 for obtaining at least one of a second HD image and a half-resolution UHD image by down-scaling the original UHD image 210. In this example, the down-scaler 220 may be included the image encoder 230, and the second down-scaler 222 may selectively generate the second HD image and the half-resolution UHD image based on a transmission capacity of a second transmission channel 270 and efficiency of a second image encoder 232. Further descriptions pertaining to the aforementioned process of using the down-scaling method in the first transmission system will be provided with reference to FIG. 3.

Also, the image encoder 230 includes a first image encoder 231 for encoding the down-scaled first HD image, and the second image encoder 232 for encoding at least one of the down-scaled second HD image and the down-scaled half-resolution UHD image. For example, the second image encoder 232 selectively reference encodes the at least one of the second HD image and the half-resolution UHD image with respect to the first HD image, based on an inter-picture prediction method.

The multiplexer 240 generates a first transmission stream by multiplexing and synchronizing audio data and various forms of additional data of the encoded first HD image, and generates a second transmission stream by multiplexing and synchronizing audio data and various forms of additional data of the at least one of the second HD image and the half-resolution UHD image.

The transmitter 250 transmits the first transmission stream via a first transmission channel 260, and transmits the second transmission stream having a transmission capacity less than a transmission capacity of the first transmission channel 260 via a second transmission channel 270. Also, the transmitter 250 includes a first error correction encoder 251 for performing error correction encoding processing on the first transmission stream and a second error correction encoder 252 for performing error correction encoding processing on the second transmission stream, and a modulator 253. For example, in a case of hierarchical modulation, the first transmission channel 260 and the second transmission channel 270 may correspond to a base layer and an enhancement layer, respectively, and in a case of a hybrid network, the first transmission channel 260 and the second transmission channel 270 may be channels differing from each other. By way of an example, in the case of the hybrid network, the first transmission channel 260 may be a broadcasting network, and the second transmission channel 270 may be an Internet protocol (IP) network.

When the first transmission system uses an advanced television system committee (ATSC) digital television broadcasting transmission method, the first image encoder 231 may correspond to a moving picture expert group (MPEG)-2 video encoder, and the first error correction encoder 251 may correspond to trellis-coded-modulation (TCM). Also, a second image encoder 232 may correspond to a high efficiency video coding (HEVC) image encoder, and the second error correction encoder 252 may correspond to a low-density parity-check (LDPC).

FIG. 3 is a diagram illustrating a process of using a down-scaling method in a first transmission system according to an embodiment of the present invention.

Referring to FIG. 3, a 4K resolution original UHD image 310 is assumed to be a 6×6 image pixel, however, in actuality, the 4K resolution original UHD image 310 may be expanded to a 3840×2160 image pixel.

When an image input to the first transmission system is the 4K resolution original UHD image 310, a first down-scaler obtains a first HD image 320 by down-scaling, for example, down sampling in operation 311, the original UHD image 310 to 4:1. For one example, the first down-scaler selects one of four image pixels of the original UHD image 310, and down samples the one selected image pixel in operation 311. For another example, in operation 311, the first down-scaler down samples the image pixel by selecting “0” from image pixels of “0, 1, 10, and 11”, selecting “2” from image pixels of “2, 3, 12, and 13”, and selecting “4” from image pixels of “4, 5, 14, and 15”.

Also, the down-scaled first HD image 320 is transmitted to a first image encoder 350 to be encoded.

A second down-scaler selectively obtains at least one of a second HD image 330 and a half-resolution UHD image 340 by down-scaling, for example, down-sampling in operations 312 and 313, the original UHD image 310 to 4:1 or 2:1 based on a transmission capacity of a second transmission channel or efficiency of a second image encoder 360. For one example, the second down-scaler selects one or two of the four image pixels in a diagonal direction of the original UHD image 310, and down samples the selected image pixel in operations 312 and 313. For another example, when one of the four image pixels is selected, the second down-scaler obtains the second HD image 330 by selecting “11” from the image pixels of “0, 1, 10, and 11”, selects “13” from the image pixels of “2, 3, 12, and 13”, selecting “15” from the image pixels of “4, 5, 14, and 15”, and down sampling the selected image pixel to 4:1 in operation 312. Alternatively, when two of the four image pixels are selected, the second down-scaler obtains the half-resolution UHD image 340 by selecting “1” and “11” from the image pixels of “0, 1, 10, and 11”, selecting “3” and “13” from the image pixels of “2, 3, 12, and 13”, selecting “5” and “15” from the image pixels of “4, 5, 14, and 15”, and down sampling the selected image pixels to 2:1 in operation 313. In this instance, the second down-scaler selects three of the four image pixels and down-samples the selected image pixels, and the first down-scaler and the second down-scaler perform anti-aliasing processing by including an anti-aliasing filter, prior to performing the down-sampling.

Also, the down-scaled second HD image 330 or the half-resolution UHD image 340 is transmitted to the second image encoder 360 to be encoded.

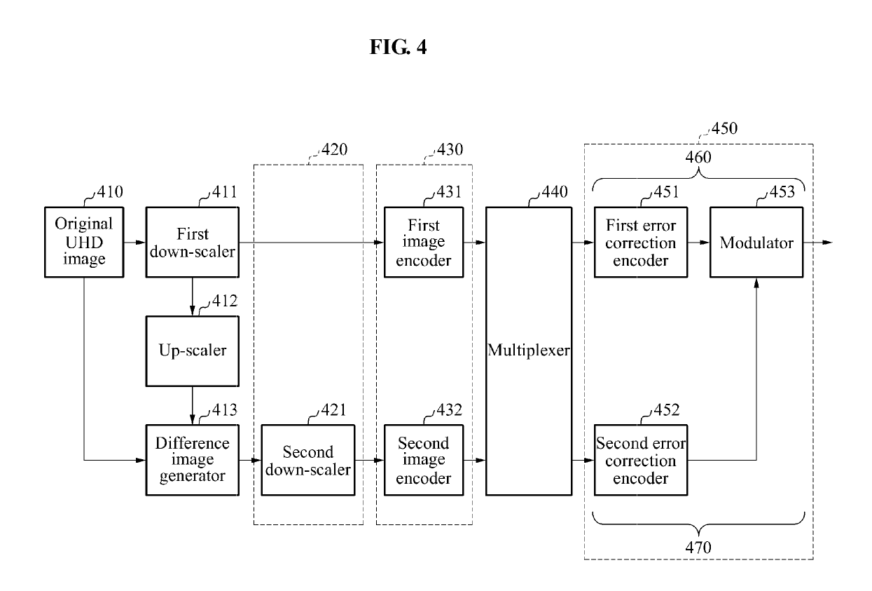

FIG. 4 is a diagram illustrating a second transmission system for transmitting an HD image and a UHD image according to an embodiment of the present invention.

Referring to FIG. 4, the second transmission system includes a first down-scaler 411, an up-scaler 412, a difference image generator 413, an image generator 420, an image encoder 430, a multiplexer 440, and a transmitter 450. For example, the first down-scaler 411 obtains a first HD image by down-scaling an original UHD image 410, and the up-scaler 412 obtains an up-scaled image by up-scaling the first HD image. Also, the difference image generator 413 generates a difference image between the original HD image 410 and the up-scaled image.

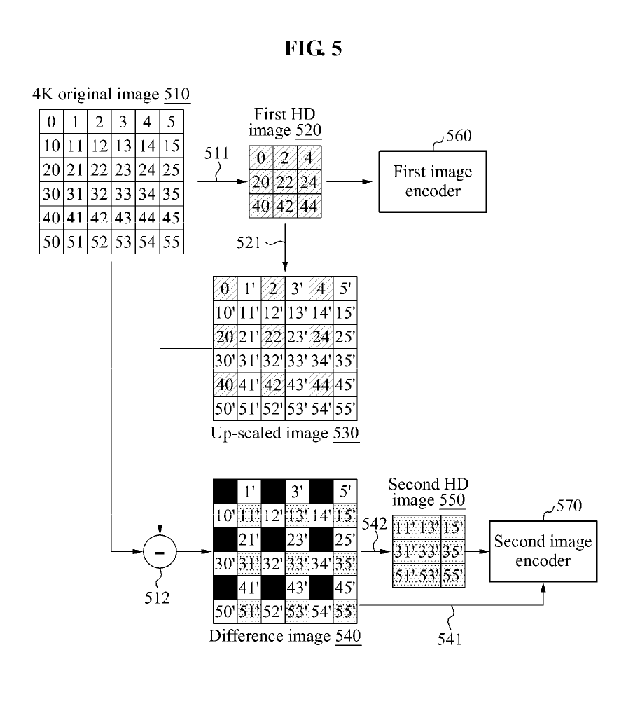

The image generator 420 provides a second HD image to the image encoder 430 by including a second down-scaler 421 for obtaining the second HD image by down-scaling the difference image between the up-scaled image and the original UHD image 410. For example, the image generator 420 transmits a UHD image corresponding to the difference image to the image encoder 430 when the second down-scaler 421 is not included. Further descriptions pertaining to the aforementioned down-scaling method and the up-scaling method in the second transmission system will be provided with reference to FIG. 5.

Also, the image encoder 430 includes a first image encoder 431 for encoding the first HD image and a second image encoder 432 for encoding at least one of the second HD image or the UHD image corresponding to the difference image.

The multiplexer 440 generates a first transmission stream by multiplexing and synchronizing audio data and various forms of additional data of the encoded first HD image, and generates a second transmission stream by multiplexing and synchronizing audio data and various forms of additional data of at least one of the second HD image and the UHD image corresponding to the difference image.

The transmitter 450 transmits the first transmission stream via a first transmission channel 460, and transmits the second transmission stream via a second transmission channel 470 having a transmission capacity less than a transmission capacity of the first transmission channel 460. Further, the transmitter 450 includes a first error correction encoder 451 for performing error correction encoding processing on the first transmission stream, and a second error correction encoder 452 for performing error correction encoding processing on the second transmission stream, and a modulator 453.

FIG. 5 is a diagram illustrating a process of using a down-scaling method and an up-scaling method in a second transmission system according to an embodiment of the present invention.

Referring to FIG. 5, a 4K resolution original UHD image 510 is assumed to be a 6×6 image pixel, however, in actuality, the 4K resolution original UHD image 510 is expanded to a 3840×2160 image pixel.

When an image input to the second transmission system is the 4K resolution original UHD image 510, a first down-scaler obtains a first HD image 520 by down-scaling, for example, down sampling in operation 511, the original UHD image 510 to 4:1. For one example, the first down-scaler selects one of four image pixels of the original UHD image 510, and down samples the one selected image pixel in operation 511. For another example, in operation 511, the first down-scaler down samples the image pixel by selecting “0” from image pixels of “0, 1, 10, and 11”, selecting “2” from image pixels of “2, 3, 12, and 13”, and selecting “4” from image pixels of “4, 5, 14, and 15”.

Also, the down-scaled first HD image 520 is transmitted to a first image encoder 560 to be encoded. Alternatively, the first HD image 520 is transmitted to an up-scaler to be up-scaled to 1:4 in operation 521, and thereby an up-scaled image 530 is obtained. For one example, the up-scaler generates, from the first HD image 520, new image pixels to be up-scaled in operation 521. For another example, the up-scaler generates new image pixels of “1′, 10′, 11′, 3′, 12′, and 13′, and 5′, 14′, and 15′” to be up-scaled in operation 521.

A difference image generator calculates a difference between the original UHD image 510 and the up-scaled image 530 in operation 512, and generates a difference image 540. For example, the difference image generator generates the difference image 540 by removing a plurality of image pixels included in the up-scaled image 530 from a plurality of image pixels included in the original UHD image 510, and obtaining new image pixels of “1′, 10′, 11′, 3′, 12′, and 13′, and 5′, 14′, and 15′” having the difference. In this example, black pixels included in the difference image 540 represent pixels having a “zero” pixel value.

The difference image 540 is transmitted, in operation 541, to a second image encoder 570 via an image generator to be encoded. In this example, the difference image 540 may be a UHD image. Alternatively, the difference image 540 is transmitted to a second down-scaler included in the image generator, and down-scaling is performed on the difference image 540 in operation 542, resulting in a second HD image 550 to be obtained. For one example, the second down-scaler obtains the second HD image 550 by selecting one of four image pixels of the difference image 540, and down sampling the selected image pixel to 4:1 in operation 542. For another example, the second down-scaler obtains the second HD image 550 by selecting “11” from the image pixels of “1″, 10″, and 11” of the difference image 540, selecting “13” from the image pixels of “3″, 12″, and 13″”, selecting “15” from the image pixels “5″, 14″, and 15”, and down sampling the selected image pixel in operation 542. The difference image 540 is down sampled in a diagonal direction, and thus a degree of image quality loss may be minimized.

Also, a UHD image corresponding to the down-scaled second HD image 550 or the difference image 540 is transmitted to a second image encoder 570 to be encoded.

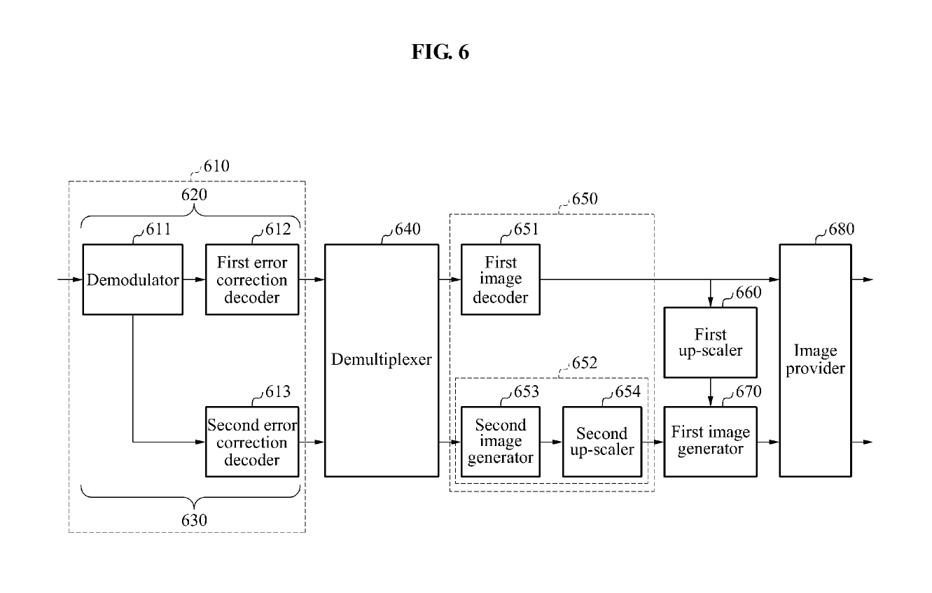

FIG. 6 is a diagram illustrating a reception system for receiving an HD image and a UHD image according to an embodiment of the present invention.

Referring to FIG. 6, the reception system includes a receiver 610, a demultiplexer 640, an image decoder 650, a first up-scaler 660, a first image generator 670, and an image provider 680. For example, the receiver 610 receives a first transmission stream via a first transmission channel 620, and receives a second transmission stream via a second transmission channel 630 having a transmission capacity less than a transmission capacity of the first transmission channel 620. Also, the receiver 610 includes a demodulater 611 for channel decoding a signal received via the first transmission channel 620 and a second transmission channel 630, a first error correction decoder 612 for performing error correction decoding processing on the first transmission stream, and a second error correction decoder 613 for performing error correction decoding processing on the second transmission stream. For example, in a case of hierarchical modulation, the first transmission channel 620 and the second transmission channel 630 may correspond to a base layer and an enhancement layer, respectively, and in a case of a hybrid network, the first transmission channel 620 and the second transmission channel 630 may be channels differing from one another. In the case of the hybrid network, the first transmission channel 620 may be a broadcasting network, and the second transmission channel 630 may be an IP network.

The demultiplexer 640 divides the first transmission stream and the second transmission stream into a video stream and an audio stream, respectively, and performs temporal synchronization.

Also, the image decoder 650 includes a first image decoder 651 for generating a first HD image by decoding the demultiplexed and synchronized first transmission stream, and a second image decoder 652 for generating a first UHD image by decoding the demultiplexed and synchronized second transmission stream. For example, the second image decoder 652 generates the first UHD image from the demultiplexed and synchronized second transmission stream by including a second image generator 653 for generating at least one of a second HD image and a half-resolution UHD image by decoding the demultiplexed and synchronized second transmission stream, and a second up-scaler 654 for generating the first UHD image by up-scaling at least one of the second HD image and the half-resolution UHD image. In this example, the second up-scaler 654 generates the first UHD image by interpolating at least one of the second HD image and the half-resolution UHD image. Alternatively, the second image decoder 652 generates the first UHD image directly from the demultiplexed and synchronized second transmission stream, absent the second image generator 653 and the second up-scaler 654.

Further, the first up-scaler 660 obtains an up-scaled image by up-scaling the first HD image, and the first image generator 670 generates a second UHD image by combining the image up-scaled from the first up-scaler 660 and the first UHD image. For example, the first image generator 670 generates the second UHD image by interpolating the image combined by the up-scaled image and the first UHD image.

As another example, the image provider 680 provides the generated first HD image and the second UHD image. For example, the first HD image may be a restored HD image received from a transmission system, and the second UHD image may be a restored UHD image received from the transmission system.

When the reception system employs an ATSC digital television broadcasting transmission method, the first image decoder 651 may correspond to an MPEG-2 video decoder, and the first error correction decoder 612 may correspond to TCM. Further, the second image decoder 652 may correspond to an HEVC image decoder, and the second error correction decoder 613 may correspond to an LDPC decoder.

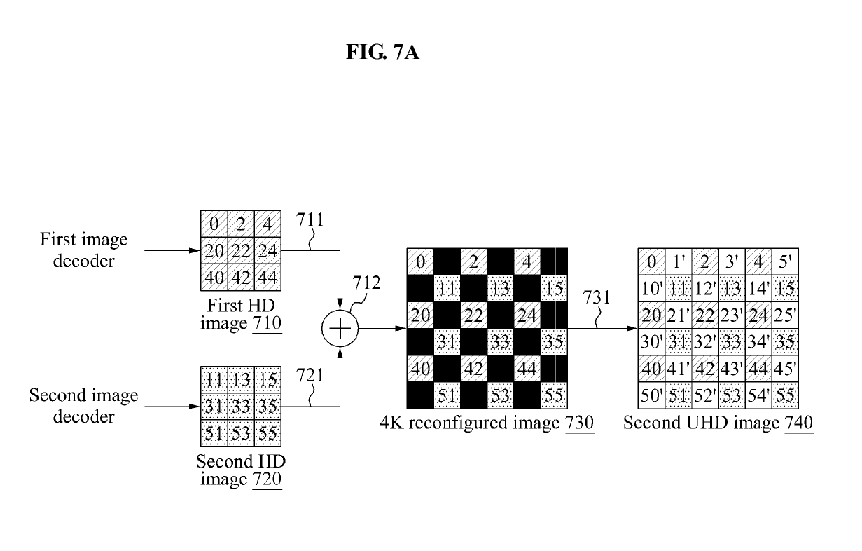

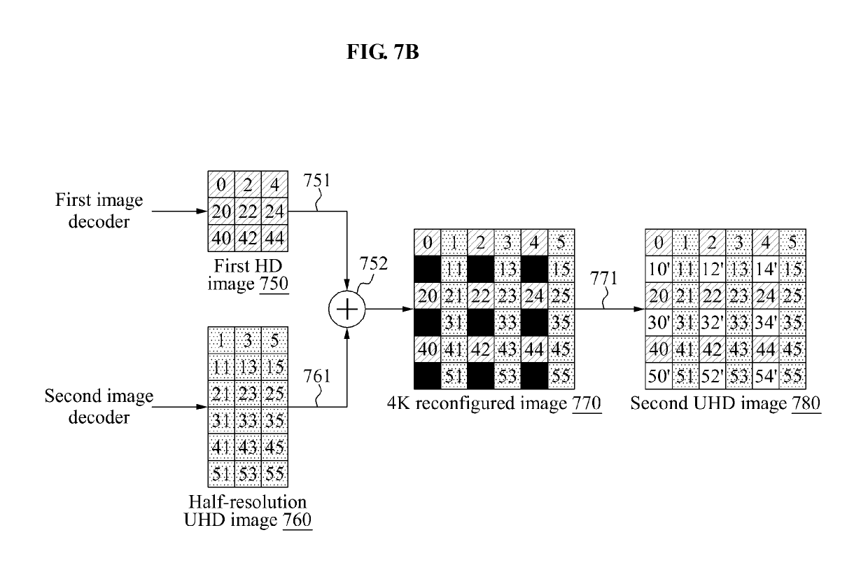

FIGS. 7A and 7B are diagrams illustrating a process of using a down-scaling method and an up-scaling method in a reception system corresponding to a first transmission system according to an embodiment of the present invention.

Referring to FIG. 7A, an up-scaled image is obtained, from a first HD image 710 generated from a first image decoder, by being up-scaled in operation 711, for example, being up sampled to 1:4, via a first up-scaler, and a first UHD image is obtained, from a second HD image 720 generated from a second image decoder, by being up-scaled in operation 721, for example, being up sampled to 1:4, via a second up-scaler.

In FIG. 7A, a first image generator generates a second UHD image 740 by combining the up-scaled image and the first UHD image in operation 712 to obtain a reconfigured image 730, and interpolating the reconfigured image 730 through use of an interpolating filter.

Conversely, referring to FIG. 7B, the up-scaled image is obtained, from a first HD image 750 generated from the first image decoder, by being up-scaled in operation 751, for example, being up sampled to 1:4, via the first up-scaler, and the first UHD image is obtained, from a half-resolution UHD image 760 generated from the second image decoder, by being up-scaled in operation 761, for example, being up sampled to 1:2, via a second up-scaler.

In FIG. 7B, the first image generator generates a second UHD image 780 by combining the up-scaled image and the first UHD image in operation 752 to obtain a reconfigured image 770, and interpolating the reconfigured image 770 through use of an interpolating filter in operation 771. Accordingly, the second UHD image 780 generated in FIG. 7B may have a superior image quality when compared to an image quality of the second UHD image 740 generated in FIG. 7A.

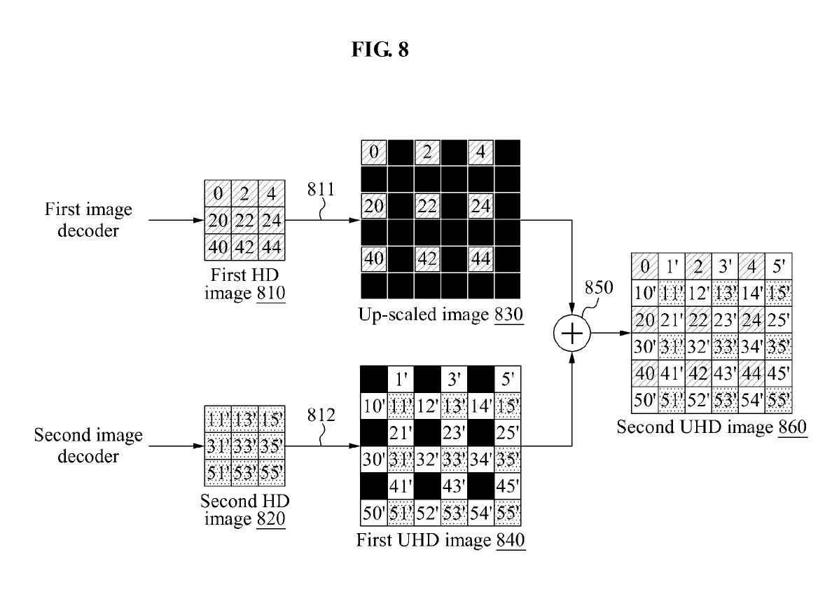

FIG. 8 is a diagram illustrating a process of using a down-scaling method and an up-scaling method in a reception system corresponding to a second transmission system according to an embodiment of the present invention.

Referring to FIG. 8, an up-scaled image 830 is obtained, from a first HD image 810 generated from a first image decoder, by being up-scaled in operation 811, for example, being up sampled to 1:4, via a first up-scaler, and a first UHD image 840 is obtained, from a second HD image 820 generated from a second image decoder, by being up-scaled in operation 821, for example, being up sampled to 1:4, via a second up-scaler. In this instance, the second up-scaler generates the first UHD image 840 by interpolating the second HD image 820 horizontally or vertically.

A first image generator generates a second UHD image 860 by combining the up-scaled image 830 and the first UHD image 840.

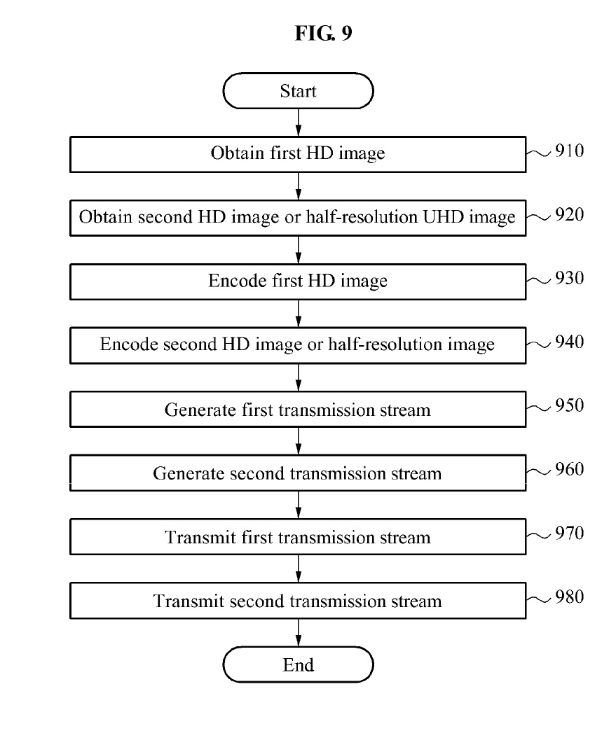

FIG. 9 is a flowchart illustrating a method of transmitting an HD image and a UHD image by a first transmission system according to an embodiment of the present invention.

Referring to FIG. 9, in operation 910, the first transmission system obtains a first HD image by down-scaling an original UHD image.

In operation 920, the first transmission system obtains at least one of a second HD image and a half-resolution UHD image by down-scaling the original UHD image.

In operation 930, the first transmission system encodes the first HD image.

In operation 940, the first transmission system encodes at least one of the second HD image and the half-resolution UHD image. In this instance, the encoding of the at least one of the second HD image and the half-resolution UHD image may further include reference encoding at least one of the second HD image and the half-resolution UHD image with reference to the first HD image based on an inter-picture prediction method.

In operation 950, the first transmission system generates a first transmission stream by multiplexing and synchronizing the encoded first HD image.

In operation 960, the first transmission system generates a second transmission stream by multiplexing and synchronizing at least one of the encoded second HD image and the encoded half-resolution UHD image.

In operation 970, the first transmission system transmits the first transmission stream via a first transmission channel. In this example, the transmitting of the first transmission stream via the first transmission channel includes performing error correction encoding processing on the first transmission stream.

In operation 980, the first transmission system transmits the second transmission stream via a second transmission channel differing from the first transmission channel. In this example, the transmitting of the second transmission stream via the second transmission channel includes performing error correction encoding processing on the second transmission stream.

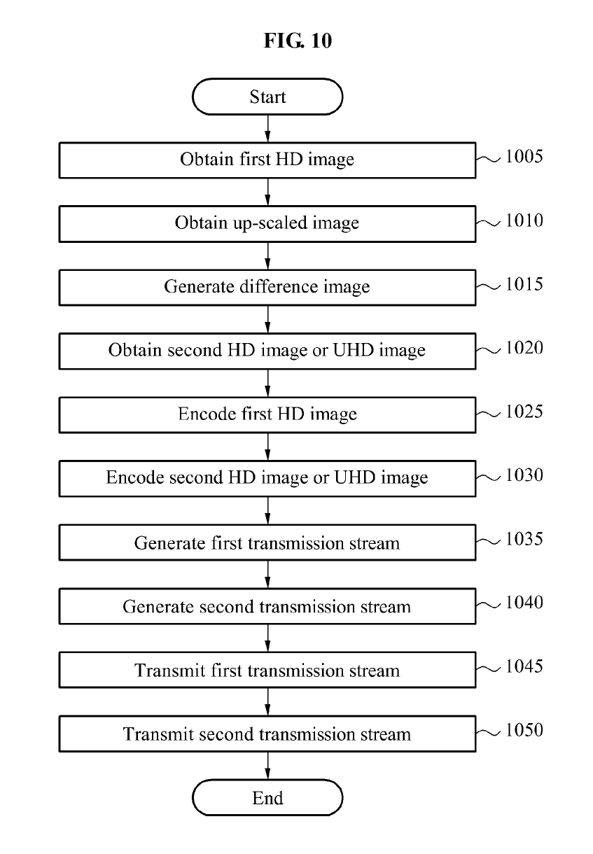

FIG. 10 is a flowchart illustrating a method of transmitting an HD image and a UHD image by a second transmission system according to an embodiment of the present invention.

Referring to FIG. 10, in operation 1005, the second transmission system obtains a first HD image by down-scaling an original UHD image.

In operation 1010, the second transmission system obtains an up-scaled image by up-scaling the first HD image.

In operation 1015, the second transmission system generates a difference image between the original UHD image and the up-scaled image.

In operation 1020, the second transmission system obtains, from the difference image, at least one of a second HD image and a UHD image corresponding to the difference image. In this instance, the obtaining of the at least one of the second HD image and the UHD image corresponding to the difference image includes obtaining the second HD image by down-scaling the difference image.

In operation 1025, the second transmission system encodes the first HD image.

In operation 1030, the second transmission system encodes at least one of the second HD image and the UHD image.

In operation 1035, the second transmission system generates a first transmission stream by multiplexing and synchronizing the encoded first HD image.

In operation 1040, the second transmission system generates a second transmission stream by multiplexing and synchronizing at least one of the encoded second HD image and the encoded UHD image.

In operation 1045, the second transmission system transmits the first transmission stream via a first transmission channel. In this example, the transmitting of the first transmission stream via the first transmission channel includes performing error correction encoding processing on the first transmission stream.

In operation 1050, the second transmission system transmits the second transmission stream via a second transmission channel differing from the first transmission channel. In this example, the transmitting of the second transmission stream via the second transmission channel includes performing error correction encoding processing on the second transmission stream.

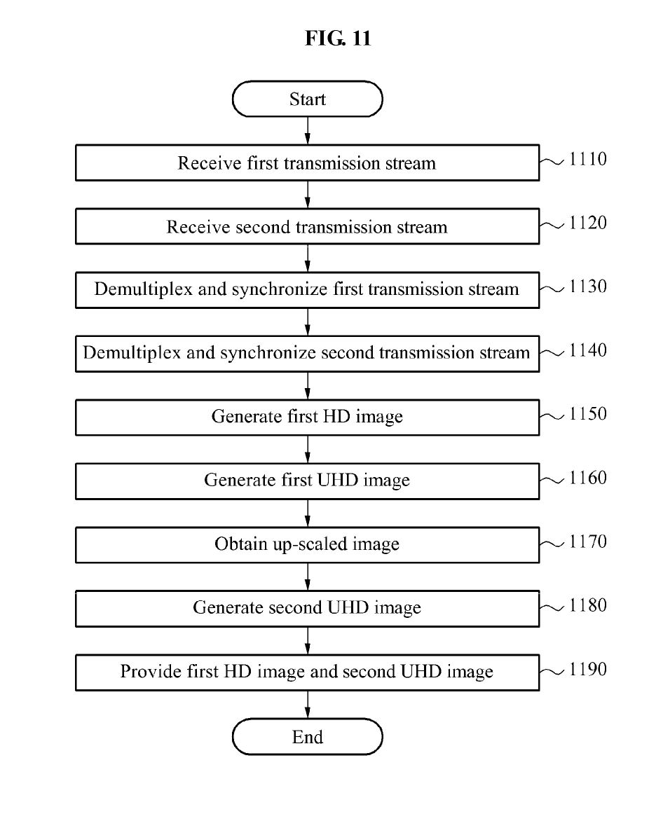

FIG. 11 is a flowchart illustrating a method of receiving an HD image and a UHD image by a reception system according to an embodiment of the present invention.

Referring to FIG. 11, in operation 1110, the reception system receives a first transmission stream via a first transmission channel. In this example, the receiving of the first transmission stream via the first transmission channel includes generating the first transmission stream by channel decoding a signal received via the first transmission channel.

In operation 1120, the reception system receives a second transmission stream via a second transmission channel differing from the first transmission channel. In this example, the receiving of the second transmission stream via the second transmission channel includes generating the second transmission stream by channel decoding a signal received via the second transmission channel.

In operation 1130, the reception system demultiplexes and synchronizes the first transmission stream.

In operation 1140, the reception system demultiplexes and synchronizes the second transmission stream.

In operation 1150, the reception system generates a first HD image by decoding the demultiplexed and synchronized first transmission stream.

In operation 1160, the reception system generates a first UHD image by decoding the demultiplexed and synchronized second transmission stream. In this example, the generating of the first UHD image by decoding the demultiplexed and synchronized second transmission stream further includes generating at least one of a second HD image and a half-resolution UHD image by decoding the demultiplexed and synchronized second transmission stream, and generating the first UHD image by up-scaling at least one of the second HD image and the half-resolution UHD image. In addition, the generating of the first UHD image by up-scaling the at least one of the second HD image and the half-resolution UHD image further includes interpolating at least one of the second HD image and the half-resolution UHD image.

In operation 1170, the reception system obtains an up-scaled image by up-scaling the first HD image.

In operation 1180, the reception system generates a second UHD image by combining the up-scaled image and the first UHD image. In this example, the generating of the second UHD image by combining the up-scaled image and the first UHD image further includes interpolating the image combined by the up-scaled image and the first UHD image.

In operation 1190, the reception system provides the first HD image and the second UHD image.

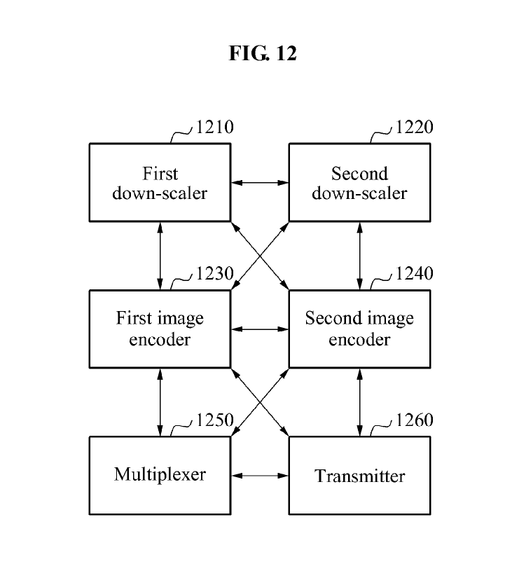

FIG. 12 is a block diagram illustrating a first transmission system according to an embodiment of the present invention.

Referring to FIG. 12, the first transmission system includes a first down-scaler 1210, a second down-scaler 1220, a first image encoder 1230, a second image encoder 1240, a multiplexer 1250, and a transmitter 1260.

The first down-scaler 1210 obtains a first HD image by down-scaling an original UHD image.

The second down-scaler 1220 obtains at least one of a second HD image and a half-resolution UHD image by down-scaling the original UHD image.

The first image encoder 1230 encodes the first HD image.

The second image encoder 1240 encodes at least one of the second HD image and the half-resolution UHD image.

The multiplexer 1250 generates a first transmission stream by multiplexing and synchronizing the encoded first HD image, and generates a second transmission stream by multiplexing and synchronizing at least one of the encoded second HD image and the encoded half-resolution UHD image.

The transmitter 1260 transmits the first transmission stream via a first transmission channel, transmits a second transmission stream via a second transmission channel differing from the first transmission channel.

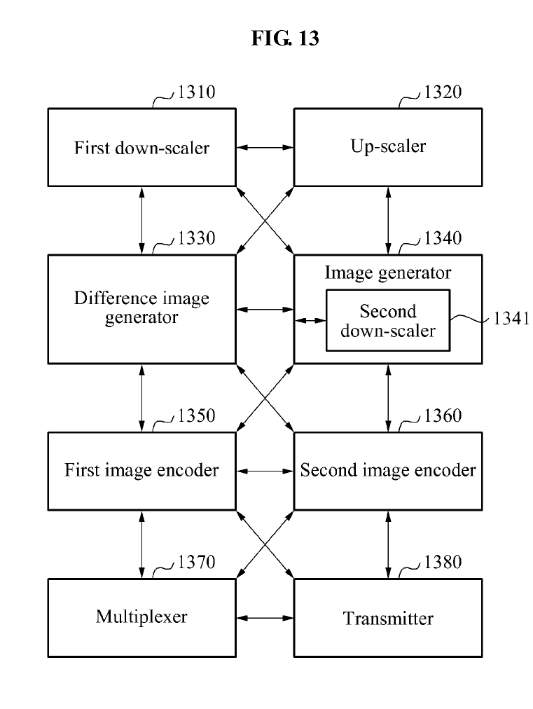

FIG. 13 is a block diagram illustrating a second transmission system according to an embodiment of the present invention.

Referring to FIG. 13, the second transmission system includes a first down-scaler 1310, an up-scaler 1320, a difference image generator 1330, an image generator 1340, a first image encoder 1350, a second image encoder 1360, a multiplexer 1370, and a transmitter 1380.

The first down-scaler 1310 obtains a first HD image by down-scaling an original UHD image.

The up-scaler 1320 obtains an up-scaled image by up-scaling the first HD image.

The difference image generator 1330 generates a difference image between the original UHD image and the up-scaled image.

The image generator 1340 obtains, from the difference image, at least one of a second HD image and a UHD image corresponding to the difference image.

Also, the image generator 1340 includes a second down-scaler 1341 for obtaining a second HD image by down-scaling the difference image.

The first image encoder 1350 encodes the first HD image.

The second image encoder 1360 encodes at least one of the second HD image and the UHD image.

The multiplexer 1370 generates a first transmission stream by multiplexing and synchronizing the encoded first HD image, and generates a second transmission stream by multiplexing and synchronizing at least one of the encoded second HD image and the encoded UHD image.

The transmitter 1380 transmits the first transmission stream via a first transmission channel, and transmits the second transmission stream via a second transmission channel differing from the first transmission channel.

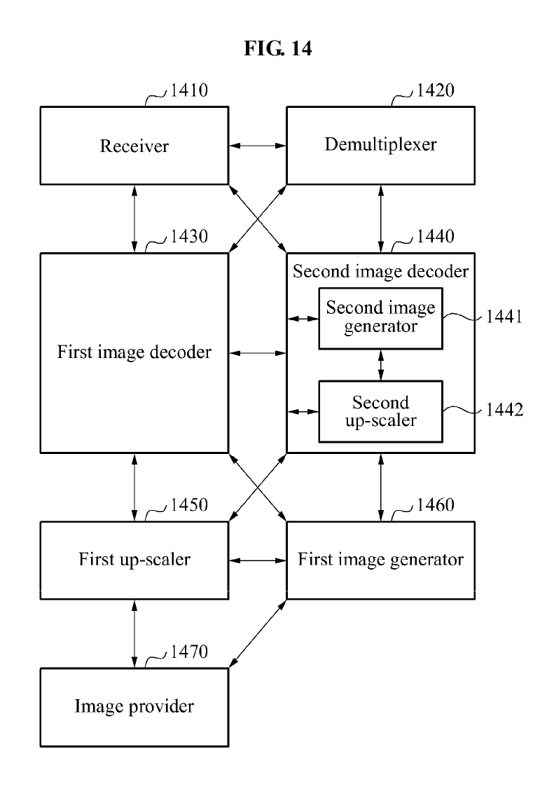

FIG. 14 is a block diagram illustrating a reception system according to an embodiment of the present invention.

Referring to FIG. 14, the reception system includes a receiver 1410, a demultiplexer 1420, a first image decoder 1430, a second image decoder 1440, a first up-scaler 1450, a first image generator 1460, and an image provider 1470.

The receiver 1410 receives a first transmission stream via a first transmission channel, and receives a second transmission stream via a second transmission channel differing from the first transmission channel.

The demultiplexer 1420 demultiplexes and synchronizes the first transmission stream, and demultiplexes and synchronizes the second transmission stream.

The first image decoder 1430 generates a first HD image by decoding the demultiplexed and synchronized first transmission stream.

The second image decoder 1440 generates a first UHD image by decoding the demultiplexed and synchronized second transmission stream.

Also, the second image decoder 1440 further includes a second image generator 1441 for generating at least one of a second HD image and a half-resolution UHD image by decoding the demultiplexed and synchronized second transmission stream, and a second up-scaler 1442 for generating a first UHD image by up-scaling at least one of the second HD image and the half-resolution UHD image.

The first up-scaler 1450 obtains an up-scaled image by up-scaling the first HD image.

The first image generator 1460 generates a second UHD image by combining the up-scaled image and the first UHD image.

The image provider 1470 provides the first HD image and the second UHD image.

The units described herein may be implemented using hardware components, software components, or a combination thereof. For example, a processing device may be implemented using one or more general-purpose or special purpose computers, such as, for example, a processor, a controller and an arithmetic logic unit (ALU), a digital signal processor, a microcomputer, a field programmable array (FPA), a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion.

The above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM discs and DVDs; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A method of transmitting a high definition (HD) image and an ultra high definition (UHD) image, the method comprising:
obtaining a first HD image by down-scaling an original UHD image;
obtaining at least one of a second HD image and a half-resolution UHD image by down-scaling the original UHD image;
encoding the first HD image;
encoding at least one of the second HD image and the half-resolution UHD image;
generating a first transmission stream by multiplexing and synchronizing the encoded first HD image;
generating a second transmission stream by multiplexing and synchronizing at least one of the encoded second HD image and the encoded half-resolution UHD image;
transmitting the first transmission stream via a first transmission channel; and
transmitting the second transmission stream via a second transmission channel differing from the first transmission channel.

2. The method of claim 1, wherein the encoding of the at least one of the second HD image and the half-resolution UHD image further comprises:
reference encoding the at least one of the second HD image and the half-resolution UHD image with respect to the first HD image, based on an inter-picture prediction method.

3. The method of claim 1, wherein the transmitting of the first transmission stream via the first transmission channel comprises:
performing error correction encoding processing on the first transmission stream, and
the transmitting of the second transmission stream via the second transmission channel differing from the first transmission channel comprises:
performing error correction encoding processing on the second transmission stream.

4. A method of transmitting a high definition (HD) image and an ultra high definition (UHD) image, the method comprising:
obtaining a first HD image by down-scaling an original UHD image;
obtaining an up-scaled image by up-scaling the first HD image;
generating a difference image between the original UHD image and the up-scaled image;
obtaining, from the difference image, at least one of the second HD image and the UHD image corresponding to the difference image;
encoding the first HD image;
encoding at least one of the second HD image and the UHD image;
generating a first transmission stream by multiplexing and synchronizing the encoded first HD image;
generating a second transmission stream by multiplexing and synchronizing at least one of the encoded second HD image and the encoded UHD image;
transmitting the first transmission stream via a first transmission channel; and
transmitting the second transmission stream via a second transmission channel distinguished from the first transmission channel.

5. The method of claim 4, wherein the obtaining of the at least one of the second HD image and the UHD image from the difference image comprises:
obtaining the second HD image by down-scaling the difference image.

6. The method of claim 4, wherein the transmitting of the first transmission stream via the first transmission channel comprises:
performing error correction encoding processing on the first transmission stream, and
the transmitting of the second transmission stream via the second transmission channel distinguished from the first transmission channel comprises:
performing error correction encoding processing on the second transmission stream.

7. A method of receiving a high definition (HD) image and an ultra high definition (UHD) image, the method comprising:
receiving a first transmission stream via a first transmission channel;
receiving a second transmission stream via a second transmission channel distinguished from the first transmission channel;
demultiplexing and synchronizing the first transmission stream;
demultiplexing and synchronizing the second transmission stream;
generating a first HD image by decoding the demultiplexed and synchronized first transmission stream;
generating the first UHD image by decoding the demultiplexed and synchronized second transmission stream;
generating an up-scaled image by up-scaling the first HD image;
generating a second UHD image by combining the up-scaled image and the first UHD image; and
providing the first HD image and the second HD image.

8. The method of claim 7, wherein the generating of the first UHD image by decoding the demultiplexed and synchronized second transmission stream further comprises:
generating at least one of a second HD image and a half-resolution UHD image by decoding the demultiplexed and synchronized second transmission stream; and
generating the first UHD image by up-scaling at least one of the second HD image and the half-resolution UHD image.

9. The method of claim 8, wherein the generating of the first UHD image by up-scaling the at least one of the second HD image and the half-resolution UHD image further comprises:
interpolating at least one of the second HD image and the half-resolution UHD image.

10. The method of claim 7, wherein the generating of the second UHD image by combining the up-scaled image and the first UHD image further comprises:
interpolating the image combined by the up-scaled image and the first UHD image.

11. The method of claim 7, wherein the receiving of the first transmission stream via the first transmission channel comprises:
generating the first transmission stream by channel decoding a signal received via the first transmission channel, and
the receiving of the second transmission stream via the second transmission channel comprises:
generating the second transmission stream by channel decoding a signal received via the second transmission channel.

12. A system for transmitting a high definition (HD) image and an ultra high definition (UHD) image, the system comprising:
a first down-scaler to obtain a first HD image by down-scaling an original UHD image;
a second down-scaler to obtain at least one of a second HD image and a half-resolution UHD image by down-scaling the original UHD image;
a first image encoder to encode the first HD image;
a second image encoder to encode at least one of the second HD image and the half-resolution UHD image;
a multiplexer to generate a first transmission stream by multiplexing and synchronizing the encoded first HD image, and generate a second transmission stream by multiplexing and synchronizing at least one of the encoded second HD image and the encoded half-resolution UHD image; and
a transmitter to transmit the first transmission stream via a first transmission channel, and transmit the second transmission stream via a second transmission channel distinguished from the first transmission channel.

13. A system for transmitting a high definition (HD) image and an ultra high definition (UHD) image, the system comprising:
a first down-scaler to obtain a first HD image by down-scaling an original UHD image;
an up-scaler to obtain an up-scaled image by up-scaling the first HD image;
a difference image generator to generate a difference image between the original UHD image and the up-scaled image;
an image generator to obtain at least one of a second HD image and a UHD image corresponding to the difference image from the difference image;
a first image encoder to encode the first HD image;
a second image encoder to encode at least one of the second HD image and the UHD image;
a multiplexer to generate a first transmission stream by multiplexing and synchronizing the encoded first HD image, and generate a second transmission stream by multiplexing and synchronizing at least one of the encoded second HD image and the encoded UHD image; and
a transmitter to transmit the first transmission stream via the first transmission channel, and transmit the second transmission stream via a second transmission channel differing from the first transmission channel.

14. The system of claim 13, wherein the image generator comprises:
a second down-scaler to obtain the second HD image by down-scaling the difference image.

15. A system for receiving a high definition (HD) image and an ultra high definition (UHD) image, the system comprising:
a receiver to receive a first transmission stream via a first transmission channel, and receive a second transmission stream via a second transmission channel distinguished from the first transmission channel;
a demultiplexer to demultiplex and synchronize the first transmission stream, and demultiplex and synchronize the second transmission stream;
a first image decoder to generate a first HD image by decoding the demultiplexed and synchronized first transmission stream;
a second image decoder to generate a first UHD image by decoding the demultiplexed and synchronized second transmission stream;
a first up-scaler to obtain an up-scaled image by up-scaling the first HD image;
a first image generator to generate a second UHD image by combining the up-scaled image and the first UHD image; and
an image provider to provide the first HD image and the second UHD image.

16. The system of claim 15, wherein the second image decoder further comprises:
a second image generator to generate at least one of a second HD image and a half-resolution UHD image by decoding the demultiplexed and synchronized second transmission stream; and
a second up-scaler to generate the first UHD image by up-scaling at least one of the second HD image and the half-resolution UHD image.
